(19) United States
(12) Patent Application Publication
(10) Pub. No.: US 2021/0245065 A1
(43) Pub. Date: Aug. 12, 2021

(54) GAME CASE OR MULTIMEDIA CASE

(71) Applicant: lndi Gaming GmbH & Co. KG, Duesseldorf (DE)

(72) Inventors: Benjamin Reichert, Duesseldorf (DE); Moritz Stoppelkamp, Duesseldorf (DE)

(73) Assignee: lndi Gaming GmbH & Co. KG, Duesseldorf (DE)

(21) Appl. No.: 16/973,287

(22) PCT Filed: Jun. 7, 2019
(86) PCT No.: PCT/EP2019/065049

§ 371 Date: Dec. 8, 2020

(30) Foreign Application Priority Data
Jun. 8, 2018 (DE) 10 2018 113 787.7

(51) Int. Cl. A63F 13/98

(52) U.S. Cl. CPC A63F 13/98

(57) ABSTRACT

The invention relates to a game case (1) for the transport and mobile operation of an integratable game console, said game case (1) having an upper shell (2) and a lower shell (3) and the upper shell (2) being connected to the lower shell (3) removably or such that it can be folded along a longitudinal side. The upper shell (2) comprises a screen (4) for outputting a signal of the integratable game console and said screen (4) occupies at least half of the surface of the upper shell (2). The lower shell (3) comprises at least one shaped element (5) and said shaped element (5) has at least one recess (6) for interlockingly accommodating the games console. The game case (1) has a ready-made wiring (7) which comprises at least one power supply line (7a) or a signal line (7b), and at least one power supply lien (7a) or signal line (7b) is inserted into the recess (6) to connect to the game console for connection to a power source or to the screen (4) to output a signal of the game console. The invention further relates to a multimedia case comprising an integrated monitor or any other integrated image display device.

The invention relates to the field of electronic entertainment games in the form of a game case for the transport and mobile operation of a game console. The invention also relates to a multimedia case with an integrated monitor or with another integrated image display device.

### PRIOR ART

Electronic entertainment games have enjoyed great and continuingly growing popularity for some time. This applies to both games which are played portably on devices specially provided for this purpose, in particular a game boy or a smartphone, as well as those which are operated stationary with a comparatively large screen and using high computing power for the realistic representation of a game environment on a game console or a standard PC. In this case, the games can be configured for one or more players. For the participation of several players, a game console can, for example, offer several operating units in the form of controllers and/or offer the possibility of connecting the game consoles of several players to one another via an Internet connection.

Experience shows that stationarily operated games with large, realistic-looking game scenes with detailed graphical representations enable the player to immerse themselves better in a game world and thus a more intense gaming experience than is usually the case with small portable devices.

In contrast to the comparatively simple portable games, the problem arises for the operation of the comparatively demanding games that their use depends on the existence of a certain infrastructure in the form of the game console, the controller, the monitor, the corresponding installation area, a power supply or energy supply on the order of about 100 to 200 watts, as well as, optionally, an Internet access.

Nevertheless, many players also want to use the game consoles provided for stationary use when traveling, for example while waiting at the airport, on the train, or at the private and/or professional vacation or work location.

To partially solve this problem, a portable gaming and entertainment system is known from the prior art from US2017/0333787 A1, which provides a case for the safe transport of the components required for the gaming environment from one location to another.

A transport case for a computer is known from US 2003/0217940 A1. In one embodiment of the case, a two-part insert shell with a lower part and an upper part is described for accommodating the computer, which enclose the computer completely when the transport case is closed. No reference is made to the use or design of this transport case in connection with game consoles.

A box for storing video games and accessories is known from DE 20 2008 002 162 U1. This box is neither intended nor suitable for arranging a game console and a monitor, as well as ready-made cables, in such a way that the box would be suitable for both transport and use of the game console.

US 2016/0306389 A1 discloses a protective housing for electronic devices, in particular for tablet computers. The protective housing is insignificantly larger than the electronic device to be protected and has, among other things, a recess for the arrangement of an electrical energy store. The protective housing is neither intended nor suitable for arranging a game console and a monitor, as well as ready-made cables, in such a way that the box would be suitable for both transport and use of the game console.

US 2005/0185916 A1 discloses a game case with a screen arranged in an upper shell and a DVD player or a game console arranged in a lower shell. A sewn compartment is provided for accommodation, which can be opened and closed again by means of a zipper for inserting and removing the DVD player or the game console.

Game cases according to the preamble of claim 1 are known from US 2016/0228768 A1 and from US 2011/0092294 A1. In these game cases, the game console is not interlockingly accommodated by a shaped element with a recess, but fixed with “straps” in such a way that at least one side face of the game console is covered exclusively by these straps and is openly accessible between the straps. As a result, the game console can be damaged by elements that are not fastened in the game case and can move in the game case when it is transported.

The object of the present invention is to provide a solution to the aforementioned problem, which is improved over the prior art and, in particular, to provide a game case and a multimedia case which enable a game console or a multimedia device to be transported easily and safely and, after transport, enable uncomplicated and short-term use.

### DISCLOSURE OF THE INVENTION

The object is achieved according to the invention by the features of the independent claims. Advantageous configurations of the invention are specified in the dependent claims.

According to the invention, a game case is provided for the transport and mobile operation of an integrable game console, said game case having a substantially cuboid shape and the largest sides of the cuboid form the top and the bottom of the game case, said game case having an upper shell and a lower shell and the upper shell being connected to the lower shell removably or such that it can be folded along a longitudinal side and can be locked at an angle between 90 degrees and 150 degrees with respect to the lower shell, the upper shell comprising a screen for outputting a signal of the integrable game console and the screen occupying at least half of the surface of the upper shell,

wherein the lower shell comprises at least one shaped element and the shaped element has at least one recess for interlockingly accommodating the game console,

wherein the game case has ready-made wiring which comprises at least one power supply line or one signal line, and at least one power supply line or signal line is inserted into the recess to connect to the game console for connection to a power source or to the screen to output a signal of the game console.

In other words, a game case is provided, the upper shell of which has a screen, in particular a flat screen, which occupies the surface of the upper shell to more than 50%, ideally in a range between 85% and 95%. This screen is permanently installed in the upper shell in order to remain and operate in the upper shell of the game case. An opened case can thus take on the task of a screen holder for operating a game console in the game case, an angle for locking the upper shell relative to the lower shell advantageously being in a range between 90 degrees and 150 degrees. The screen has a rear ventilation. Said rear ventilation can be provided, for example, by the fact that the screen does not completely occupy the surface of the upper shell. However, ventilation openings can also be arranged in the upper shell, which ventilation openings, however, create an opening in the outer skin of the game case, which can otherwise be configured to be closed in order to be watertight.

Advantageously, the height of the upper shell and the installation depth of the screen are matched to one another in such a way that the screen surface is arranged within the upper shell or, in order to be able to make the game case as small as possible, is approximately flush with the edge of the upper shell.

Furthermore, the lower shell has a shaped element in which a game console can be interlockingly inserted. In this case, the shaped element can advantageously be configured of an elastic and/or resilient material, for example foam. In this context, interlockingly means that the recess is configured for the housing shape of a game console in such a way that said game console can be inserted into the recess from above, and that the shaped element, in particular a foam, surrounds the game console from below and from the side in such a way that the game console is fixed from these sides and cushioned against shocks. Interlocking does not rule out that such a sheathing is interrupted by the shaped element, for example in order to influence the spring constant of an elastic and/or resilient material by forming ribs or in order to provide ventilation slots.

The game case has a ready-made wiring, which allows wiring the game console inside the case and inside the shaped element. In this case, the wiring comprises at least one power supply line or a signal line, advantageously, however, all of the power supply or connection lines required to operate the game console. At least one power supply line or signal line, advantageously, however, all lines to be connected to the game console for operation, are installed in the game case and are ready to be connected to the game console for connecting the game console to a power source and/or the screen. For this purpose, they are inserted into the recess, so that a game console that is usually already present only has to be connected to the given cables in order to enable operation after a very short installation time. In this case, pre-installation of the connection lines enables a convenient and error-free start-up procedure. Existing connection lines from a stationary environment do not have to be removed and taken along. Furthermore, there is no risk of lines getting lost on the way or being damaged by repeated folding, winding and kinking. The correct, ready-made length prevents tangled cables and lines from being pinched when the game case is closed.

Furthermore, the game case enables the game console to be transported in an operational state. Once inserted, the game console inside the game case can be put into operation within a few seconds. Starting the game console is therefore very convenient, so that operation is also worthwhile if only short periods of time, for example for bridging short waiting times, are available.

Advantageously, the game case can have an energy store, for example a power bank. Depending on the power consumption of the game console and the power bank used, playing times of about an hour are currently possible. If the game console only allows operation with a supply voltage of 110 V or 220 V, the game case can have a voltage converter for converting a direct voltage to a mains voltage of 110 V or 220 V. Furthermore advantageously, the game case has a charging station for the power bank and/or a radio communication device, in particular a box with plug contacts in USB format or an induction charger to enable the power supply for a radio communication device, in particular a smartphone. The latter can, for example, be connectable to the game console and have the function of a relay station in order to establish a connection between the game console and the Internet. In this way, the game case can be used to provide a player with the use of the game console in the usual way, also in a mobile manner.

In an advantageous configuration, the game case comprises at least one shaped element, which has at least one recess for accommodating one or more components of the game case, in the form of at least one recess for accommodating an operating unit of the game console, in particular a controller, and/or a recess for accommodating a cable, in particular a mains cable, and/or a recess for accommodating a data carrier of a game, in particular in Blu-ray or DVD format, and/or a recess for accommodating a charging station for a radio communication device, in particular a box with plug contacts in USB format or an induction charger, and/or a recess for accommodating an energy store, in particular a power bank, and/or a recess for accommodating a current transformer, in particular for converting a direct voltage to a mains voltage of 220 V.

One or more such recesses offer the advantage of forming compartments for the transport and/or storage of game components and/or game accessories. The game case thus offers the possibility of be able to transport and/or accommodate all necessary and optional components or accessories together. Corresponding recesses improve the overview and the check for completeness. Advantageously, the recesses can accommodate the game components and/or the game accessories in an interlocking manner in order to prevent their movements in the game case.

In the case of several recesses, these can all be configured in one shaped element or distributed over several shaped elements. Advantageously, all shaped elements in combination, in the form of a puzzle, or the one shaped element alone completely occupy the surface of the lower shell. In this case, by a slight oversize, the sides of one or more, preferably elastic shaped elements are pressed against the side walls and optionally against each other and in this way a fixation in the lower shell can be achieved. Advantageously, the shaped element or the combination of shaped elements completely occupies the lower shell approximately flush with its side edge. The side edge of a suitcase is often reinforced or the wall material is turned over at the side edge. Advantageously, the game case has a reinforcement of the side wall by which the shaped element or the combination of shaped elements is fixed in the lower shell against movement upwards.

In an advantageous configuration, one or more shaped elements have at least one guide channel for at least partially accommodating wiring. Such guide channels protect the connection lines from being pinched by the case shells or between the components of the game case when the game case is closed. In an advantageous configuration, wiring of electrical components of the lower shell of the game case is completely covered in one or more guide channels.

Furthermore advantageously, the upper shell or the lower shell of the game case has a plug connection, in particular a device plug, for connecting a mains cable, in particular a cable coupling. In conjunction with the internal wiring, the plug connection offers the advantage that all components can be connected to a supply network via a common network connection, with the mains cable being easy to separate from the game case for transport. An external plug connection also offers the advantage that the game case can also be supplied with energy when closed, in order to be able to charge a power bank, for example.

Advantageously, the plug connection is arranged in the upper shell of the game case, which tends to offer more free space behind the screen than the lower shell. Furthermore advantageously, the wiring connects the device plug with the screen and with the power supply line ready-made for the game console and, optionally, with the charging station.

In the event that the game case is modularly constructed from several shaped elements, at least part of the wiring and at least the shaped element for accommodating the game console can be configured to be interchangeable for adaptation to the connections and the design of the game console. A modular design of the shaped elements of the game case thus offers the advantage that individual shaped elements of the game case can be exchanged separately and buying a new game console does not require buying a new game case.

In order to enable a high packing density of the components, it can, however, be advantageous for the lower shell to have only a single, solely occupying, shaped element with a plurality of recesses of the type described above. To still be able to accommodate the game consoles of different manufacturers and/or generations, the game case is configured in such a way that the lower shell can alternatively be occupied with a plurality of shaped elements that occupy alone.

Furthermore advantageously, the shaped element for accommodating the game console has a recess or opening on one or more sides surrounding the game console, which form an air duct for upwardly supplying supply air and/or upwardly discharging exhaust air when the game console is inserted, in order to enable air circulation necessary for cooling.

Alternatively or in addition, the shaped element for accommodating the game console can have at least one tunnel on one or more sides surrounding the game console, which tunnel enables a supply of supply air and/or a discharge of exhaust air into another or from another recess of the same or an adjacent shaped element. On the one hand, a tunnel offers in this case the advantage that it enables a better interlocking between the game console and the shaped element, since the upper edge surrounding the game console does not have to be interrupted. On the other hand, a tunnel offers the advantage that a higher packing density of the components can be achieved, since the other recess has a double role as an air duct and as a recess for accommodating game components or accessories.

In this case, a tunnel advantageously opens into a recess, the shape of which is configured to accommodate a component of the game case which is removed for a game operation. It can be, for example, a recess for a controller or a recess for the mains cable, without the use of which game operation is not possible or makes no sense. Such a configuration reduces the risk of an air duct being clogged or covered and an air circulation being impaired. In an advantageous embodiment, the game case can have a temperature monitor that monitors the air temperature in a duct or a recess and initiates a warning and/or shutdown if one or more predeterminable temperatures is exceeded.

In an advantageous embodiment of the game case, the air is circulated via a combination of both ventilation variants, for example the supply air can be supplied via a cable recess and a controller recess, and the exhaust air can be discharged via a lateral air duct.

Furthermore advantageously, the game case has a counter-element for at least one shaped element, through the bottom of which counter element a game component can be fixed in a recess upwardly and which, when the game case is closed and lying down, completely occupies a space between the game component and the screen in the vertical extension, and at least partially in the horizontal extension.

Furthermore advantageously, the screen is configured in this case as a flat screen and at least one recess is configured in such a way that an inserted component is flush at the top with the shaped element and the counter element is configured in the form of a flat cover.

Such a counter element, a foam plate configured as a flat cover in a preferred embodiment, on the one hand, fulfills the task of fixing the game components and the game accessories in their recesses, and also covering the lower shell of the game case, and with the game case closed, protecting the surface of the flat screen from the game console and the game components. For this purpose, the counter element advantageously comprises an elastic and/or cushioning material. In an advantageous configuration, the surface of the counter element substantially can correspond to the area of the lower shell and cover it flush with the side edge.

In an embodiment of the game case, the upper shell of the game case can be configured to be removable. This variant offers the advantage that the upper shell can be positioned with the screen independently of the lower shell. Advantageously, the upper shell has its own energy store for supplying the screen and a radio communication interface, for example wireless HDMI, for transmitting the signal of the game console. In one configuration, the upper and lower shells have charging contacts via which an energy store in the upper shell can be automatically charged when it is placed on the lower shell, provided, for example, the lower shell is connected to a supply network.

Furthermore advantageously, the game case has a removable trolley holder. Here, the removable trolley holder has the advantage that it is not a hindrance during gaming operations, but on the other hand it makes it easier to transport the game case.

In order to reduce the weight of the game case, in an advantageous embodiment of the invention, instead of being placed inside the game case, an energy store can also be arranged outside the game case, for example on a removable trolley holder.

The application also describes a removable trolley holder with an electrical energy store for supplying energy to a case, in particular the above-described game case. The trolley holder can have an integrated charger for charging the energy store.

Furthermore, in an advantageous configuration, the trolley holder can comprise a voltage converter for providing a mains voltage, in particular 110 V or 220 V. For feeding an electrical device, in particular a game case, advantageously, the trolley holder comprises a plug connection for power supply, in particular a mains cable with a cable coupling. In an advantageous configuration, the same mains cable can be used to connect the integrated charger to a supply network.

In a further advantageous configuration, the trolley holder has an extendable linkage which comprises two rigid rails connected to one another with crosspieces, and wherein the energy store and/or the voltage converter is advantageously at least partially arranged in the space spanned by the rigid elements.

The invention also relates to a game case or multimedia case with an upper shell and a lower shell that are connected to one another so that they can be folded and/or removed, wherein the upper shell or the lower shell has a display device for outputting a signal from a multimedia device or a signal of a game console and wherein the upper shell or the lower shell comprises at least one shaped element. In this case, the shaped element has at least one fluid chamber and is configured in such a way that the shaped element can be filled with a fluid in order to improve or achieve a fixing effect of a multimedia device inserted into the shaped element or a game console inserted into the shaped element, in the fluid-filled state. Preferably, a valve is provided in order to introduce fluid into the fluid chamber and to remove it from it again. The fluid chamber can be configured and adapted to a game console or a multimedia device in such a way that the filling with fluid, in particular with air, results in an increasing clamping force with increasing pressure. Alternatively or in addition, a configuration can also be provided which effects an interlocking accommodation on all sides by filling the fluid chamber with fluid, in particular air. For this purpose, for example, an edge surrounding the game console or the multimedia device on the top side can be provided, which during filling is filled with fluid and creates an interlocking that excludes the removal of the inserted game console or an inserted multimedia device. As a result, a game console or a multimedia device can be arranged in a particularly secure manner and, in particular, free of play in every direction. Another advantage is that the fluid chamber filled with air or another fluid, in particular a gaseous fluid, provides advantageous shock absorption. This configuration can also be combined with any other technical features of this disclosure.

The invention also relates to a game case or multimedia case with an upper shell and a lower shell which are foldably and/or removably connected to one another, wherein the upper shell or the lower shell has a display device for outputting a signal of a multimedia device or a signal of a game console, and wherein the upper shell or the lower shell has at least one shaped element, and wherein at least one opening with a light outlet for a lens of a projector is formed and/or height-adjustable feet are provided in the upper shell and/or in the lower shell. This embodiment also, which has the advantage that a projector transported with the case can not only be easily transported, but can also be operated from this case, can be combined with any other technical features of this disclosure.

Finally, reference is also made to a game case or multimedia case with an upper shell and a lower shell, which are foldably and/or removably connected to one another, wherein the upper shell or the lower shell has a display device for outputting a signal of a multimedia device or a signal of a game console, and wherein in the area of at least one side face a pivotable surface element is provided which is formed for storing and operating a keyboard or mouse and/or for fastening a keyboard. This embodiment also, which, in particular, has the advantage that a keyboard and/or mouse can not only be transported easily and safely, but can also be used in conjunction with the case and the fold-out surface element immediately after it has been unfolded, can be combined with any other technical features of this disclosure. A particular advantage is that it can also be used where there is no suitable surface, e.g. in sandy or rocky areas, where putting down or using the keyboard or mouse would be associated with the risk of damaging them and/or where they cannot be used without complications.

### DRAWINGS

The invention is explained in more detail below with reference to the attached schematic drawings using preferred embodiments.

FIG. 1 shows a sketch of a game case for the transport and mobile operation of an integrable game console in perspective illustration;

FIG. 2 shows a sketch of a shaped element for filling the interior of a game case according to FIG. 1 in a perspective illustration;

FIG. 3 shows a sketch of a game case of FIG. 1, in which the lower shell is closed with a flat cover, in a perspective illustration;

FIG. 4 shows a vertical section of the shaped element of FIG. 2;

FIG. 5 shows a plan view of the shaped element of FIG. 2;

FIG. 6 shows a sketch of an embodiment of a folded multimedia case for the transport and mobile operation of a multimedia device that can be accommodated therein in a perspective illustration from the front at an angle and from above;

FIG. 7 shows a sketch of the multimedia case of FIG. 6 in the folded state in perspective illustration from behind at an angle and from above;

FIG. 8 shows a sketch of the multimedia case of FIGS. 6 and 7 in an unfolded state from the front at an angle and from above;

FIG. 9 shows a sketch of the multimedia case of FIGS. 6 to 8 in the unfolded state from behind at an angle and from above;

FIG. 10 shows a sketch of a further embodiment of a lying, unfolded multimedia case for the transport and mobile operation of a multimedia device, in particular a camera, in a perspective illustration from the front at an angle and from above;

FIG. 11 shows a sketch of the multimedia case of FIG. 10 in the upright folded state in a perspective illustration from behind at an angle and from above;

FIG. 12 shows a sketch of the multimedia case of FIGS. 10 and 11 in the same perspective illustration as in FIG. 10 with the upper shaped element removed;

FIG. 13 shows a sketch of an embodiment of a folded multimedia case for the transport and mobile operation of a multimedia device that can be accommodated therein in a perspective illustration from the front at an angle and from above;

FIG. 14 shows a sketch of the multimedia case of FIG. 13 in the folded state in perspective illustration from behind at an angle and from above;

FIG. 15 shows the multimedia case of FIGS. 13 and 14 in the unfolded state in perspective illustration from the front at an angle and from above,

FIG. 16 shows the multimedia case of FIGS. 13 to 16 in the unfolded state in perspective illustration from behind at an angle and from above.

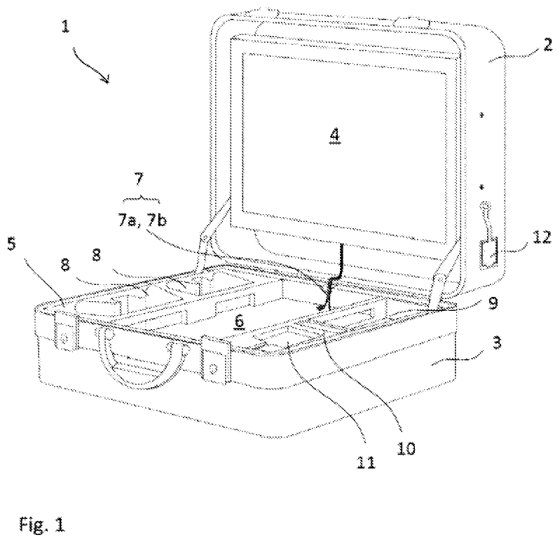

FIG. 1 shows a game case 1 for the transport and mobile operation of an integrable game console, said game case 1 having a substantially cuboid shape and the largest sides of the cuboid form the top and the bottom of the game case 1, said game case 1 having an upper shell 2 and a lower shell 3 and the upper shell 2 being connected to the lower shell 3 removably or such that it can be folded along a longitudinal side and can be locked at an angle between 90 degrees and 150 degrees with respect to the lower shell 3.

The upper shell 2 comprises a screen 4 for outputting a signal of the integrable game console and wherein the screen 4 occupies more than 50% of the surface of the upper shell 2.

The lower shell 3 comprises a shaped element 5, which has a recess 6 for interlocking accommodation of the game console and a ready-made wiring 7 which comprises at least one power supply line 7a or one signal line 7b.

The power supply line 7a or signal line 7b is inserted into the recess 6 for connection to a power source or to the screen 4 to output a signal.

Furthermore, it can be seen from FIG. 1 that the shaped element 5 also has several recesses for accommodating components of the game case 1. It can be seen that here are two recesses 8 for accommodating two operating units of the game console, in particular two controllers, a recess 9 for accommodating a cable, in particular a mains cable, a recess 10 for accommodating a box with plug contacts in USB format and a recess 11 for accommodating an induction charger.

Furthermore, the game case 1 on its upper shell 2 has an external plug connection 12 in the form of a device plug for connecting a mains cable, in particular a cable coupling. The plug connection 12 can be covered against the ingress of dirt and/or moisture.

The plug connection 12 is connected to the screen 4 and to the power supply line 7a ready-made for the game console via the wiring 7.

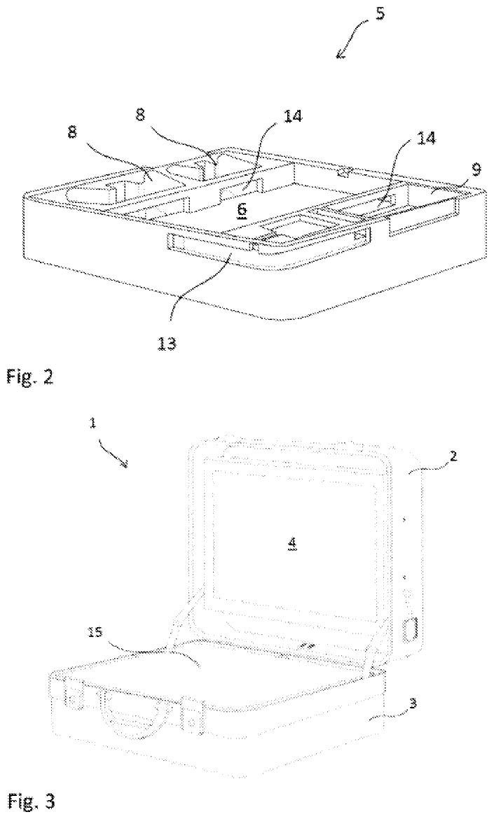

As can be seen from FIG. 2, the shape of the shaped element 5 corresponds to the shape of the interior of the lower shell 3. The shaped element 5 is suitable for completely filling the lower shell 3.

Furthermore, it can be seen from FIG. 2 that the shaped element 5 has at least one guide channel 13 for at least partially accommodating a wiring 7. This guide channel 13 as well as other guide channels not visible in this illustration enable the wiring 7 of electrical components of lower shell 3 of game case 1, with the exception of the part of wiring 7 between upper shell 2 and lower shell 3, to be completely covered in guide channels in the manner of guide channel 13.

As can be seen from FIG. 2, the shaped element 5 has several tunnels 14 for accommodating the game console on one or more sides of the recess 6 for the game console, which tunnels enable a supply of supply air and/or a discharge of exhaust air into adjacent recesses 8 and 9 of the same shaped element 5.

Both tunnels 14 open into recesses 8, 9, the shape of which is configured to accommodate components of the game case 1, which components are removed for game operation. In FIG. 2, these recesses are a recess 8 for accommodating a controller and the recess 9 for accommodating a mains cable.

As can be seen from FIG. 3, the screen 4 is configured as a flat screen. When the game case 1 is closed, the surface of the screen 4 is protected by a counter element 15 in the form of a flat cover. The surface of the counter element 15 substantially corresponds to the surface of the lower shell 3 and covers it flush with the lateral edge.

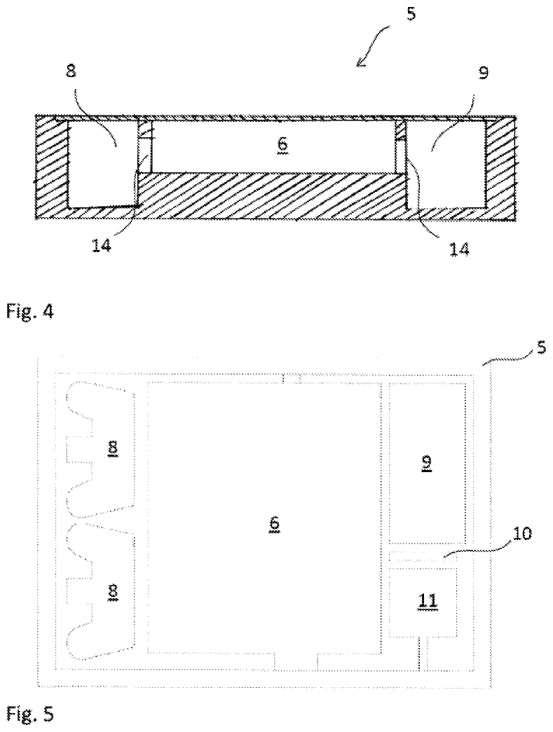

FIG. 4 shows a section through the shaped element 5, from which it can be seen that the recesses 6, 8, 9 and, also visible in this section, the recesses 10 and 11, are configured to have different depths in the shaped element 5, in such a way that the upper sides of the associated inserted game components are flush with the shaped element 5. This has the effect that the game components can be fixed upwardly through the bottom of the counter element 15 in their respective recesses 6, 8, 9, 10, 11 and that when the game case 1 is closed and lying down, a space between the respective component and the screen 4 in a vertical extension is filled completely and at least partially in the horizontal extension by the counter element 15. Furthermore, the channels 14 for aeration and/or ventilation can be seen from FIG. 4.

FIG. 5 shows a plan view of the shaped element 5, from which it can be seen that the recesses 6, 8, 9, 10, 11 in the horizontal plane are configured for interlockingly accommodating the respective game components provided for the recesses 6, 8, 9, 10, 11, such as the controllers, for example.

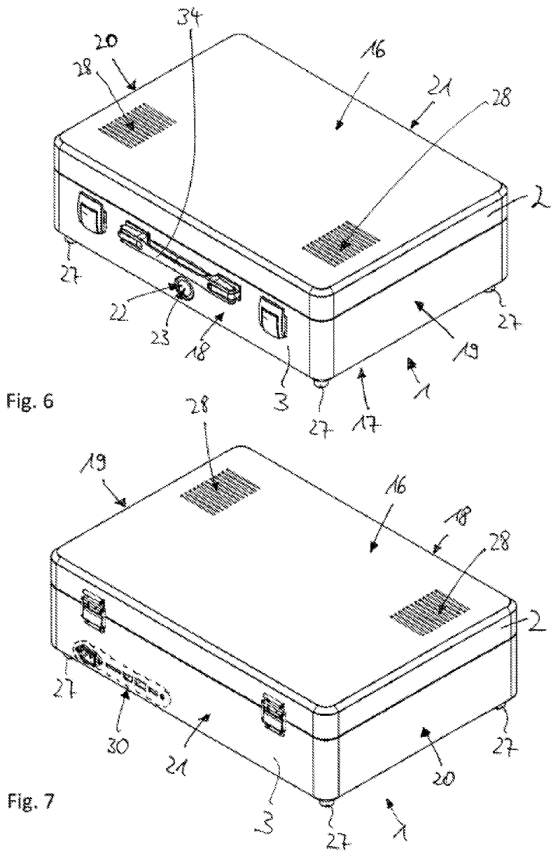

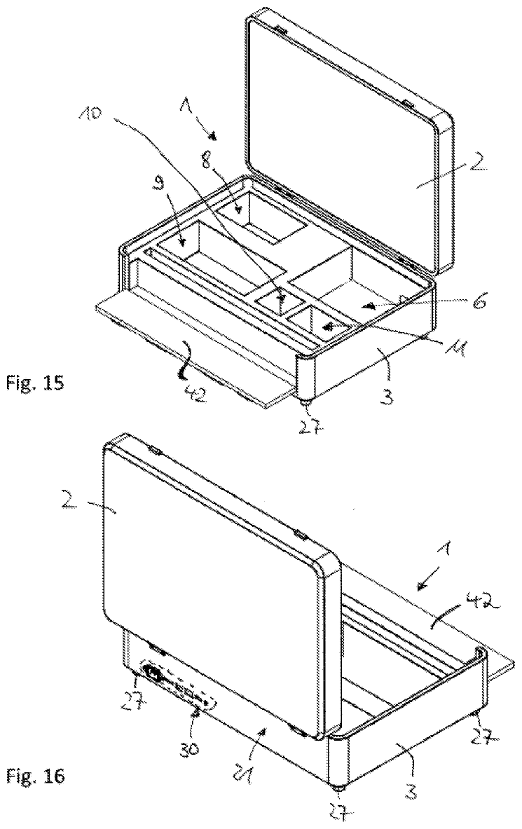

FIGS. 6 to 9, 10 to 12 and 15 to 18 show embodiments of multimedia cases 1, which can also be configured as game cases 1. Provided that functionally identical features are apparent as shown in FIGS. 1 to 6, the configuration of multimedia cases 1 matches the configuration of the embodiment described above, unless the configuration is described differently in the following or a different configuration is apparent to a person skilled in the art from the illustrations.

FIGS. 6 to 9 show a further embodiment of a multimedia case 1, which also has a substantially cuboid basic shape with a top 16, a bottom 17, a front side face 18, lateral side faces 19, 20 and a rear side face 21. In this case, in the area of one of the surfaces 17, 18, 19, 20 or sides 16, 17, here on the front side face 18, an opening 22 with a light outlet for a lens 23 of a multimedia device is formed in the form of a projector 24.

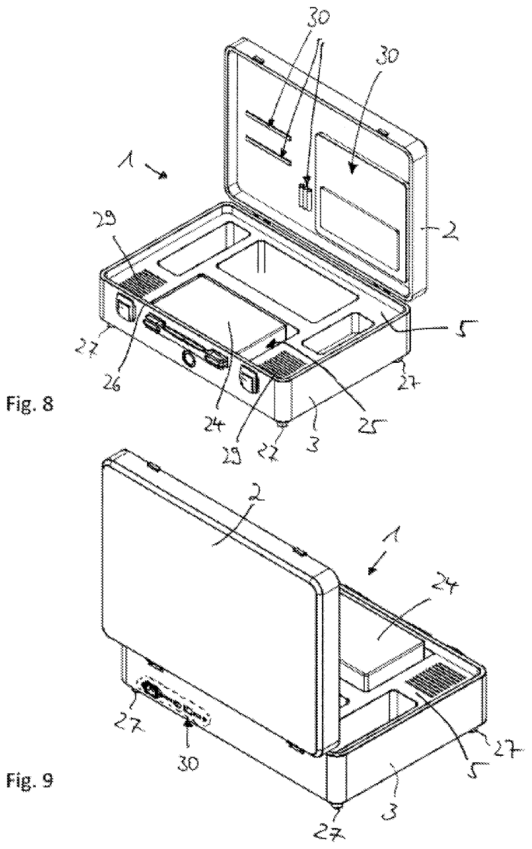

As can be seen from FIGS. 8 and 9, for this purpose the projector 24 is arranged in a recess 25 of a shaped element 5 inserted in the lower shell 3. This recess 25 for the projector 24 is formed in this configuration in such a way that the projector 24 is surrounded from three sides by the recess 25 of the shaped element 5 and from another side by the wall 26 of the lower shell 3. One or more air slots (not shown) are located in the shaped element in order to be able to ensure sufficient ventilation and cooling of the projector 24 even when the multimedia case 1 with the projector 24 is operated in the closed state.

In the upper shell 2, fastening and stowage options 30 are provided for further utensils, in particular pouches (not shown), laser pointers, pens and other objects.

In the area of the bottom 17, four height-adjustable feet 27 are provided, here each in the area of the corners, in order to be able to orient the transport case 1, in particular during operation of the projector 24, so that the image projected by the projector 24 on a projection surface has a desired position and orientation.

In the upper shell 2, sound outlet openings 28 for loudspeakers 29 are provided, which are arranged in the lower shell 3. The sound outlet openings 28 are not shown in FIG. 9 because they are closed in the state shown in the figure with elements not shown in detail in order to make the multimedia case 1 waterproof or at least water-protected.

In FIG. 7 it can be clearly seen that a plurality of connections 31 are arranged in the area of the rear side face, in particular at least one AUX, USB, HDMI, LAN and network connection as well as a slot for accommodating a memory card, such as, for example, an SD card or the like.

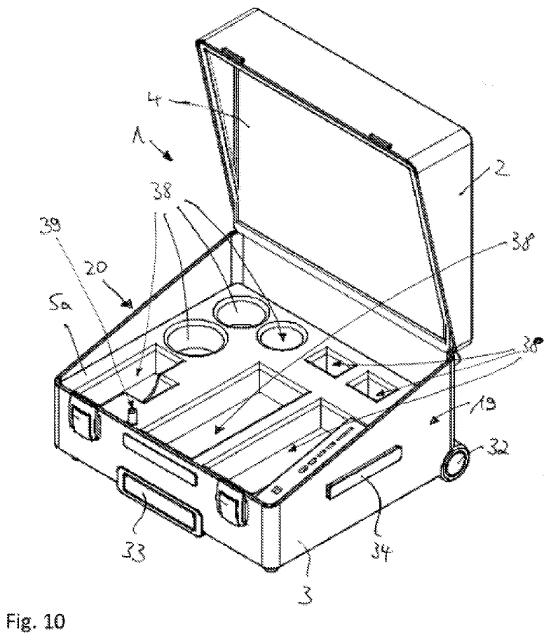

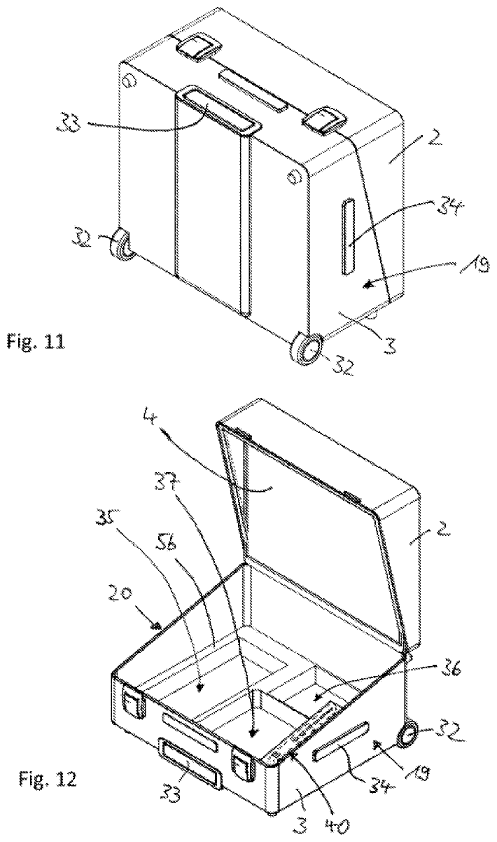

FIGS. 10 to 12 show an embodiment of a multimedia case 1 which an integrated transport system and transport rollers 32. Furthermore, an extendable handle 33 is provided, which is shown in FIG. 11 in the retracted state. Further carry handles 34 are located in the area of the lateral side faces 19, 20.

In the lower shell 3, two shaped elements 5a, 5b are arranged one above the other, so that two levels are formed. The lower shaped element 5b has recesses 35, 36, 37 for accommodating a computer unit (not shown), a keyboard (not shown), a mouse (not shown) or a trackpad (not shown).

The shaped element 5a immediately above likewise has various recesses 38, in particular for a camera, lenses and other accessories.

The shaped element 5a inlay can be pressurized and filled with air via a valve 39 in order to secure the equipment inserted into the recesses 38 with a clamping force—or, if the recesses 38 are suitably configured, with an undercut (not shown) even interlockingly—without any damage.

In the right area of the lower shell 3 of the multimedia case 1, various connections 40 are provided, in particular a USB, HDMI and LAN connection and/or an SD card reader.

A screen 4 is fixed in the upper shell 2, in particular a 19 inch monitor, which protects the screen surface from environmental reflections due to the side walls protruding laterally from the screen surface and the upper wall.

In addition, there is a canopy (not shown), in particular made of fabric, in the upper shell 2, which can be unfolded to protect the screen 4 even better from reflections.

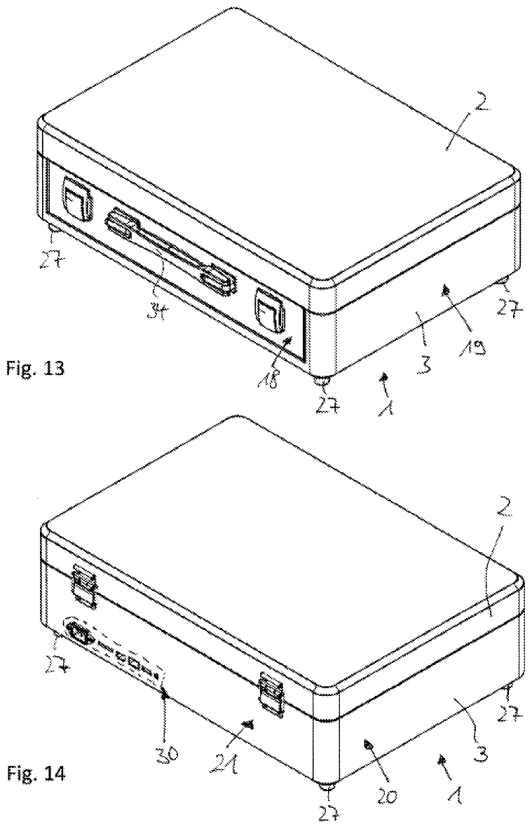

FIGS. 13 to 16 show another multimedia case 1 which substantially corresponds to the configuration of the multimedia case from FIGS. 6 to 9. For identical or at least functionally equivalent elements the same reference numerals are used throughout the entire disclosure. The multimedia case 1 shown in FIGS. 13-16 can be configured, for example, in such a way that a classic PC with a stand-alone housing (not shown) can be accommodated lying or standing in a correspondingly configured recess 6 of a shaped element 5. In this case, the shaped element can in particular be formed from a foam part and/or from one or more fluid chambers which can be filled via at least one valve (not shown). On the rear side face 21 there are in turn several connections 30, in particular at least one USB, HDMI and/or LAN connection, an SD card reader and/or a mains connection. A pivotable surface element 42 in the form of a flap is provided on the front side face 18 of the lower shell 3, which flap is formed to accommodate a keyboard (not shown). The surface element 42 can be unlocked and locked by means of a closure (not shown), in particular arranged on the inside, or by means of several closures, a lock being provided in particular in the upwardly folded state. The surface element 42 is optionally configured so that the keyboard, not shown, can be fixed to it. For this purpose, corresponding fixing elements (not shown) can be formed or arranged on the surface element 42. Further recesses 8, 9, 10, 11 are provided for the optional accommodation of a mouse, a headset, a mains cable, a controller or other accessories. A screen (not shown) is preferably arranged in the upper shell. The multimedia case 1 according to FIGS. 13 to 16 makes it possible to transport a classic stand-alone PC such as a notebook or a laptop and to use it immediately after opening the upper shell 2 and the surface element 42. Optionally, another surface element (not shown) can be provided, which is configured for fixing a mouse and/or, in the unfolded state, for using a mouse. For this purpose, it is particularly suitable to form one of the lateral side faces 19, 20 of the lower shell 3 also to be pivotable. To create a movement area for the mouse that is wider than the height of the lower shell 3, the surface element (not shown) for the mouse can have an extension in order to be able to extend two or more surface elements to form a large area and to be able to retract them again. Alternatively, two or more surfaces can in turn be fastened to one another such that they can be folded with respect to one another.

### LIST OF REFERENCE NUMERALS

1 game case or multimedia case
2 upper shell
3 lower shell
4 screen
5, 5a, 5b shaped element
6 recess
7 wiring
8 recess
9 recess
10 recess
11 recess
12 plug connection
13 guide channel
14 tunnel
15 counter element
16 top
17 bottom
18 front side face
19 lateral side face
20 lateral side face
21 rear side face
22 opening
23 lens
24 projector
25 recess
26 wall
27 foot
28 sound outlet opening
29 speaker
30 connections
31 storage options
32 transport role
33 handle
34 carry handle
35 recess
36 recess
37 recess
38 recess
39 valve
40 connections
41 display device
42 surface element

1-15. (canceled)

16. A game case for the transport and mobile operation of an integrable game console, the game case comprising a substantially cuboid shape and with largest sides thereof defining the top and the bottom of the game case, the game case having an upper shell and a lower shell, the upper shell being removably connected to the lower shell or such that the upper shell can be folded along a longitudinal side of the game case and can be locked at an angle between 90 degrees and 150 degrees with respect to the lower shell, the upper shell including a screen for outputting a signal of the game console, the screen occupying at least half of a surface of the upper shell, the lower shell having at least one shaped element, the at least one shaped element having at least one recess for interlockingly accommodating the game console, the game case having ready-made wiring which comprises at least one power supply line or at least one signal line, the at least one power supply line or the at least one signal line inserted into the at least one recess to connect to the game console for connection to a power source or to the screen to output a signal of the game console.

17. The game case according to claim 16, wherein the at least one shaped element has at least one additional recess for accommodating one or more components of the game case, an operating unit of the game console, a cable, a data carrier of a game, a charging station for a radio communication device, an energy store, and/or a current transformer.

18. The game case according to claim 16, wherein the at least one shaped element completely occupies an internal surface of the lower shell.

19. The game case according to claim 16, wherein the at least one shaped element has at least one guide channel for at least partially accommodating a wiring.

20. The game case according to claim 19, wherein the wiring of electrical components of the lower shell of the game case is arranged in the at least one guide channel in a completely covered manner.

21. The game case according to claim 20, wherein the upper shell or the lower shell has a plug connection for connecting a mains cable.

22. The game case according to claim 21, wherein the wiring connects the plug connection to the screen and to the at least one power supply line.

23. The game case according to claim 16, wherein:
a) the game case has a modular structure, and wherein part of a wiring of the game case and the at least one shaped element are configured interchangeably for adaptation to different connections and configurations of the game console for accommodating the game console;
and/or
b) the at least one recess exceeds a size for an interlock or the at least one shaped element defines an additional opening at one or more sides of the at least one recess for accommodating the game console, which enables an upward supply of supply air and/or an upward discharge of exhaust air when the game console is inserted in the at least one recess.

24. The game case according to claim 16, wherein the at least one shaped element includes at least one tunnel on one or more sides of the at least one recess for accommodating the game console, the at least one tunnel enabling a supply of supply air and/or a discharge of exhaust air into another recess, or from another recess, of a same or neighboring shaped element.

25. The game case according to claim 24, wherein the at least one tunnel opens into the at least one recess, a fit of which is configured to accommodate a component of the game case, which component is removed for a gaming operation.

26. The game case according to claim 16, wherein the game case has a counter element for the at least one shaped element, through a bottom of which a component can be fixed upwards in the at least one recess and which, when the game case is closed and lying, occupies a gap between the component and the screen completely in a vertical extension and at least partially in a horizontal extension.

27. The game case according to claim 26, wherein the screen is configured as a flat screen, and the at least one recess is configured such that an inserted component is flush at the top with the at least one shaped element and the counter element has a shape of a flat cover.

28. A game case or multimedia case with an upper shell and a lower shell which are foldably and/or removably connected to one another, wherein the upper shell or the lower shell has a display device for outputting a signal of a multimedia device or a signal of a game console, and wherein the upper shell or the lower shell has at least one shaped element, wherein the at least one shaped element has at least one fluid chamber and is configured in such a way that the at least one shaped element can be filled with a fluid in order to improve or achieve a fixing effect of a multimedia device inserted into the at least one shaped element or a game console inserted into the at least one shaped element, in a state filled with the fluid.

29. The game case or multimedia case according to claim 28, wherein at least one opening with a light outlet for a lens of a projector is formed and/or height-adjustable feet are provided in the upper shell and/or in the lower shell.

30. The game case or multimedia case according to claim 28, wherein a pivotable surface element is provided in an area of at least one side face of the game case which is formed for storing and operating a keyboard or mouse and/or for attaching a keyboard.
